(19) United States
(12) Patent Application Publication
(10) Pub. No.: US 2017/0109658 A1
(43) Pub. Date: Apr. 20, 2017

(54) SYSTEMS AND METHODS FOR FORMING A GROUP USING A DEDICATED DATABASE

(71) Applicant: Amadeus S.A.S., Biot (FR)

(72) Inventors: Ghislaine El Azhar, Antibes Juan les Pins (FR); Delphine Caron, Antibes (FR); Christelle Arlaud, Biot (FR); Vanessa Fontebride, Le Rouret (FR); Romdhane Deghais, Antibes Juan les Pins (FR)

(21) Appl. No.: 14/883,272

(22) Filed: Oct. 14, 2015

(51) Int. Cl. G06Q 10/02; G06Q 50/00; G06Q 50/14; G06Q 30/06

(52) U.S. Cl. CPC G06Q 10/02; G06Q 30/0631; G06Q 50/01; G06Q 50/14

(57) ABSTRACT

Systems, methods, and computer program products for forming a travel group. A first travel record containing a travel reservation for a first social network user is stored in a database. The travel reservation is published as a trip publication on a social networking system. An inquiry related to the trip publication is received via the social networking system from a client device associated with a second social network user. In response to receiving the inquiry, the one or more processors generate one or more offers for a second trip based on data in the first travel record. A second travel record containing the one or more offers is stored in the database. A link between the first travel record and the second travel record is assigned in a booking folder stored in the database. The one or more offers are communicated to the client device of the second social network user.

### BACKGROUND

The invention generally relates to computers and computer software and, in particular, to systems, methods, and computer program products for forming a group.

Computer technology is increasingly used in the travel industry to manage and support travel reservations, as well as data associated with travel reservations. In particular, third party reservation agents, such as travel agents and/or customers (e.g., travelers), often utilize computer-based devices to interface with a travel reservation system, such as a global distribution system, to book travel arrangements and/or travel-related services for the customer. In general, the travel reservation system facilitates the booking/reservation of one or more travel inventory items for a traveler, where a travel inventory item refers to a perishable and saleable unit associated with a travel service (e.g., a ticket for a flight, a ticket for rail travel, a night for a hotel accommodation, etc.) maintained in an inventory of such items.

Individual bookings may be challenging to coordinate for a group of travelers headed to a common destination. For example, an individual may plan a trip and want to be accompanied on the trip by other travelers. This individual may attempt to organize a group trip by sharing information (e.g., departure airport, destination, dates and times) regarding the trip individually with other potential travelers. The information may be shared in person, over the phone, by texting, or via electronic mail.

Following these notifications, each individual wanting to join the organizer of the group trip may individually book his or her own reservation. Individual bookings permit specificities (e.g., a different departure airport or departure date than the trip organizer) to be handled, which enhances personal flexibility in making the travel arrangements. However, the travel group lacks coherency because the travel records created by the individual bookings are independent of, and unlinked with, each other.

Another approach to group travel is for all travelers to be booked with the same itinerary under the single reservation so that the trip details of all travelers in the entire group appear in a single travel record. Under this approach to group travel, the group of travelers is coherent, but the specificities of different travelers cannot be accommodated when the reservation is booked. Coherency is achieved by sacrificing the flexibility of individual bookings

Improved systems, methods, and computer program products for forming a travel group are needed that improve the speed and accuracy with which trips can be organized among multiple individual travelers while taking into account the constraints of each particular traveler of the travel group.

### SUMMARY

Embodiments of the invention are directed to systems, methods and computer program products for forming a travel group using a dedicated database. A first travel record containing a travel reservation for a first social network user is stored in the database. The travel reservation is published as a trip publication on a social networking system. An inquiry related to the trip publication is received via the social networking system from a client device associated with a second social network user. In response to receiving the inquiry, the one or more processors generate one or more offers for a second trip based on data in the first travel record. A second travel record containing the one or more offers is stored in the database. A link between the first travel record and the second travel record is assigned in a booking folder stored in the database. The one or more offers are communicated to the client device of the second social network user.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including a group travel management system in communication via a network with other systems.

FIG. 2 is a flow chart illustrating a process that by which a trip owner can share a trip over a social networking system with the assistance of the group travel management system.

FIG. 3 is a flow chart illustrating a process that by which a social network user can join the shared trip using the group travel management system.

FIG. 4 is a diagrammatic view of an exemplary computing system for hosting the group travel management system or other systems of FIG. 1.

### DETAILED DESCRIPTION

Embodiments of the invention may be implemented by a processing and database system. The processing and database system may comprise one or more computerized sub-systems that cooperate to automatically compute proposals that are presented as offers to social network relationships and connections (e.g., friends) who want to participate in a trip based on the trip organizer's booking and each participant's constraints, and that may cooperate to check the trip consistency between the reservations of all participants in the travel group. Group management is simplified by the connection to the social network and its relationships and connections. Relationship and connection management is a basic feature of a social network, and can be leveraged to manage group travel.

In accordance with the embodiments of the invention, the flexibility of group travel can be improved by creating individual travel records for the different travel reservations (which provides flexibility and specificities handling) and linking the individual travel records via a booking folder. The utilization of the booking folder may improve the ability to manage the coherence between the individual travel records.

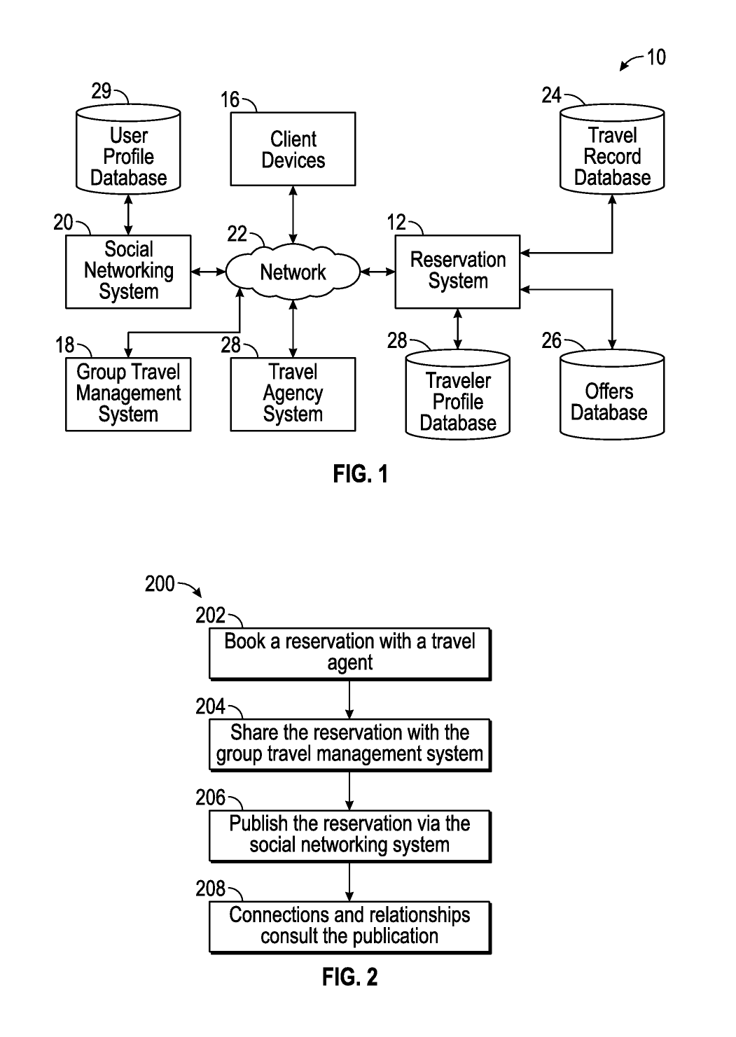

Referring now to FIG. 1, an operating environment 10 in accordance with an embodiment of the invention may include a reservation system 12, a travel agency system 14, client devices 16 associated with travelers, a group travel management system 18, and a social networking system 20 that are connected with each other through a network 22. The network 22 may include portions of one or more private or public networks (e.g., the Internet, a virtual private network, a local area network, a wide area network, a cellular telephone network, etc.) that provide interconnection and facilitate the exchange of data containing information. The social networking system 20 may be operated by a different business entity from business entities operating the reservation system 12, the travel agency system 14, client devices 16, and the group travel management system 18. In an embodiment, the group travel management system 18 may be integrated with the reservation system 12 and operated by the same business entity.

The reservation system 12 may manage information and conduct transactions related to availability, pricing, reserving, and booking of travel products, such as flights, hotels, automobile rentals, etc. The reservation system 12 may enable users, such as agents at the travel agency system 14, to search for travel products reserve, and then book and ticket travel products. The reservation system 12 may also respond to queries received from the travel agency system 14, client devices 16, or the group travel management system 18 to build or retrieve itinerary data. In the context of air travel, the reservation system 12 may respond to travel itinerary queries from the travel agency system 14 by identifying particular flights that satisfy a desired set of travel itinerary characteristics, and to make or book reservations for air travel products. The reservation system 12 may be embodied in a global distribution system, which is a type of reservation system that reserves, books, and tickets travel products for multiple travel service providers.

The reservation system 12 and/or the group travel management system 18 may include or have access to a travel record database 24. The travel record database 24 stores travel records (e.g., a passenger name record), where each travel record includes elements representing traveler information and a travel reservation detailing one or more reserved travel products, auxiliary services, and other travel-related information for one or more travelers. As will be appreciated, when travel products are booked to create a reservation, the reservation system 12 may generate a travel record in the travel record database 24 that contains elements relating to the bookings and related information of the travel reservation. Each travel record may be identified and tracked by a unique record locator assigned by the reservation system 12. The travel record database 24 may use booking folders to aggregate multiple travel records together and to perform unified actions on each booking folder.

The reservation system 12 and/or the group travel management system 18 may include or have access to an offers database 26 that facilitates pre-booking activities for an agent at the travel agency system 14. The offers database 26 maintains records that contain the information about quotes for travel products, i.e., travel proposals, sent to travelers before bookings are made. The pre-booking travel proposals stored in a record may be based on real-time availability and pricing, and can be refreshed to ensure information is up-to-date. However, the offers are not confirmed bookings The travel proposals stored in the offers database 26 are accessible for use by the reservation system 12.

The reservation system 12 and/or the group travel management system 18 may include or have access to a traveler profile database 28 that includes and maintains profile data characterizing travelers, such as travelers who are associated with the client devices 16. The profile data in the traveler profile database 28 may be maintained by the travelers using the client devices and/or the travel agency system 14, and may be shared with authorized parties, such as the travel agency system 14.

The travel agency system 14 may be used by a travel agent to book travel by remotely interfacing with the reservation system 12 that in turn interfaces with inventory systems of one or more travel product providers to determine availability and to book one or more travel products. The travel agent may use the travel agency system 14 to create and/or modify a travel record by initiating a reservation session with the reservation system 12.

Each client device 16 may be an electronic device including hardware, software, or embedded logic components and capable of carrying out supported functionalities. Representative client devices 16 may include a computer system such as a desktop computer, or a mobile electronic device such as a notebook or laptop computer, a tablet computer a cellular telephone, a smartphone, etc. Each client device 16 may enable its user to communicate with other users at other client devices 16, the travel agency system 14, and the group travel management system 18 via the network 22.

The social networking system 20 provides users of an online social network with the ability to communicate and interact with each other users. Users may join the online social network via social networking system 20 and then establish connections or relationships with a number of other users of social networking system 20. A user of the social networking system 20 may be categorized as a friend of another user of social networking system 20 with whom the user has defined a connection, association, or relationship via the social networking system 20. The social networking system 20 may store social graphs incorporating the user-defined connections, associations, and relationships in one or more data stores that are remote from the client devices 16 of the users.

The social networking system 20 may include or have access to a user profile database 29 that contains a profile for each user subscribing to the social networking system 20. A user profile includes data fields containing information describing various attributes of the corresponding social networking system user. For example, the user profile may contain biographic, demographic, and other types of descriptive information (employment, education, personal preferences, interests, location, images, videos, etc.). A unique identifier may be assigned to each user of the social networking system 20 and may be associated with the user profile in the user profile database 29.

The social networking system 20 may provide users with the ability to take actions on various types of items or objects supported by the social networking system 20. For example, the items and objects may include travel reservations booked using the client devices 16 and shared with friends using the group travel management system 18. Each client device 16 through the actions of its user and the group travel management system 18 may access social-networking functionality by interactively communicating with the social networking system 20. For example, each user has the ability to interact with the social networking system 20 by posting content to the social networking system 20, which is stored by the social networking system 20 as user-generated content objects. The social networking system 20 may provide a platform through which the group travel management system 18 can provide social-networking services and functionality to users at the client devices 16 over the network 22.

Each client device 16 may include a web browser that can be used to enter a Uniform Resource Locator (URL) or other address directing the web browser to a particular server, such as a server of the social networking system 20 or a server of the group travel management system 18, and the web browser may generate a Hyper Text Transfer Protocol (HTTP) request and communicate the HTTP request to the particular server. In response to the HTTP request, the server communicates one or more Hyper Text Markup Language (HTML) files, Extensible Markup Language (XML) files, etc. to the client device 16. Based on the received files, the client device 16 may render and present one or more webpages to the user. A webpage may execute scripts written in a scripting language such as JAVASCRIPT, JAVA, or another dynamic programming language.

The social networking system 20 may be capable of linking a variety of entities, such as the group travel management system 18 with the client devices 16. In particular, the social networking system 20 may enable users to interact with each other, as well as receive content from the group travel management system 18, and may enable users at the client devices 16 to interact with the group travel management system 18 through an application programming interface (API) or other communication channel. The group travel management system 18 may also publish content to the client devices 16 and receive content from the client devices 16 via the social networking system 20 through a communication channel, such as an application programming interface (API). For example, the group travel management system 18 may be instructed by the client device 16 of a user to share a travel reservation with other users of the social networking system 20, which is routed via the social networking system 20 for publication to the client devices 16 of other users. As another example, the group travel management system 18 may receive contact information and constraints from the client device 16 of another user routed via the social networking system 20 to book a travel reservation to join the trip of the user who instructed the publication of the travel reservation.

Each user of the social networking system 20 may subscribe to or register with an application at the group travel management system 18. The group travel management system 18 may permit a user of the social networking system 20 to share a reservation with other users of the social networking system 20 and permit these other social network users to join the trip associated with the trip owner's reservation as trip participants. A social network user may navigate to the application at the group travel management system 18 by, for example, name searching in a search bar or at an application center for the social networking system 20. Before using the group travel management system 18, a user may authorize the application to allow the usage of personal data, such as first name, last name, email address, list of friends, profile picture, etc. from his or her social network profile.

During the authorization process, the group travel management system 18 can access the identification of the subscribing user in a data store at the social networking system 20. The group travel management system 18 may search in the list of traveler profiles in the traveler profile database 28 to attempt to identify a matching traveler profile based on the social network identification of the subscribing user. The traveler profile may contain basic data, such as the real identity (first name, last name) to ensure consistency of the travel record for use in real bookings and trips, an e-mail address for sending offer details to the social network user in an offer notice, contact information (e.g., a phone number) that can be used by the travel agency to contact the user, etc.

If a corresponding traveler is not identified in the traveler profile database 28, a new traveler profile may be created for the subscribing user and stored in the traveler profile database 28. The elements in the new traveler profile may be populated with personal data supplied as input by the subscribing user. The social network identification of the user may be included as an element in the new traveler profile in the traveler profile database 28. Due to this linkage with the traveler profile in the traveler profile database 28, the social network user will not have to enter personal data each future instance of use of the application at the group travel management system 18.

With reference to FIG. 2, a flow-chart illustrates a process 200 that by which a trip owner can share a trip over the social networking system 20 with the assistance of the group travel management system 18. While FIG. 2 illustrates exemplary functions, acts, and/or operations according to an embodiment, other embodiments may omit, add to, reorder, and/or modify any of the functions, acts, and/or operations shown in FIG. 2. One or more of the functions, acts, and/or operations shown in FIG. 2 may be performed by any component or combination of components in the operating environment 10.

In block 202, a user of the social network may use his or her client device 16 to initiate a session with a travel agency system 14 in order to book travel arrangements (i.e., a trip). During the session, the social network user may interact with his or her client device 16 to book one or more travel products to create a reservation, which is recorded as a travel record for the social network user in the travel record database 24. The travel record may include traveler information and reservation information for the one or more reserved travel products, auxiliary services, and other travel-related information that constitute the travel products of the trip. The travel record may store the information in in one or more data fields using one or more of a plurality of data structures, such as strings, numbers, or Boolean flags.

In block 204, the social network user with the existing reservation may want to organize a travel group using the group travel management system 18. In particular, a social network user may use his or her client device 16 to initiate a session with the group travel management system 18. To that end, the trip represented by the existing reservation of the trip owner may be shared with other users of the social networking system 20 via a notification initiated by the group travel management system 18 using the social network API. The trip owner may share a trip with public visibility if this feature is available on the social networking system 20, or to a more limited populations of users (e.g., friends). The trip owner may also update the reservation with a notification to other users of the social network using the social network API. To that end, if a trip owner decides to change his travel details, the trip owner may share an updated reservation with relationships and contacts via an updated publication.

When the reservation is publicly shared, this social network user becomes a trip owner designated by the group travel management system 18. A reservation may be added based on the record locator for the travel record corresponding to the reservation and, if there are several passengers in the same booking, the name of the passenger in the travel record to select. Security checks may be performed to ensure that the confirmation number and the name match. If the security check passes, the reservation is linked to the user profile in the user profile database 29 of the social networking system 20 and also linked to the traveler profile in the traveler profile database 28. The trip owner may be designated by the group travel management system 18 as the social network user with permission to invite other social network users to join the trip.

In block 206, a social network user who is a trip owner may publish a trip to the client devices 16 via the social networking system 20 through a communication channel (e.g., an application programming interface (API)). For example, the group travel management system 18 may be instructed by the client device 16 of the trip owner to share a travel reservation with other users of the social networking system 20, which is routed via the social networking system 20 for publication to the client devices 16 of other users. When a trip owner wants to invite a particular friend to join his trip, the trip owner can target one or more friends by sharing his or her trip directly with each friend. In this situation, each targeted friend has the ability to join the trip to the exclusion of other social network users that are not classified as friends.

In block 208, users of the social networking system 20 may view and comment on the published trip of the trip owner contingent on the security set at publication level by the users themselves. As soon as a social network user has authorized the application at the group travel management system, the user has the ability to interact (e.g., join, clone, etc.) the published trip of the trip owner using the application at the group travel management system 18.

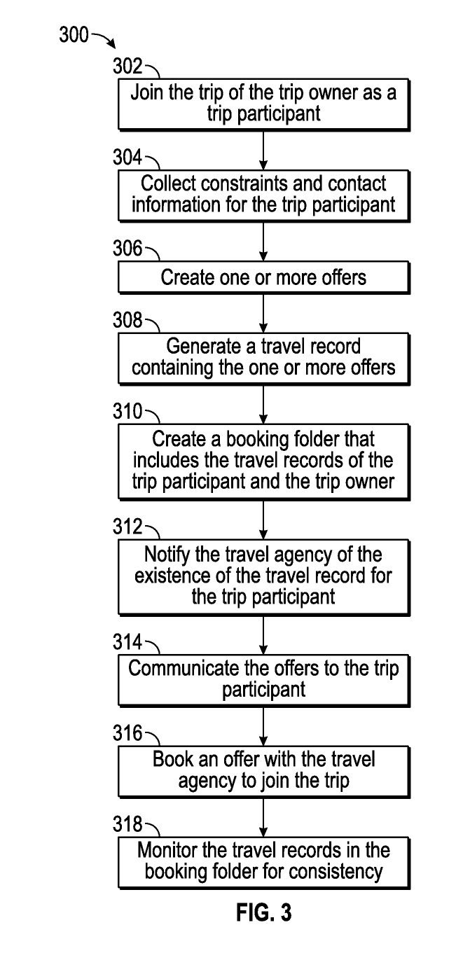

FIG. 3 is a flow-chart illustrating a process 300 by which a social network user can join a shared trip using the group travel management system 18. While FIG. 3 illustrates exemplary functions, acts, and/or operations according to an embodiment, other embodiments may omit, add to, reorder, and/or modify any of the functions, acts, and/or operations shown in FIG. 3. One or more of the functions, acts, and/or operations shown in FIG. 3 may be performed by any component or combination of components in the operating environment 10.

In block 302, a social network user may elect to join a trip that has been previously shared by the trip owner via publication over the social networking system 20. The publication of the trip by the trip owner at the social networking system 20 represents the entry point for other social network users to the application at the group travel management system 18. The ability to join a trip may depend on the privacy settings defined by the trip owner on his or her social network account, which is typical for publications. A social network user may use his or her client device 16 to initiate a session with the group travel management system 18 via the social networking system 20 in order to view details of the published trip of the trip owner and, upon request, to receive offers for travel arrangements to potentially join the published trip.

In block 304, a social network user seeking to join the trip as a trip participant may provide constraints (e.g., geographic constraints and/or date constraints) and/or contact information as input data to the group travel management system 18 during the session as a preparatory action in order to receiving offers. If the social network user is determined to have a pre-existing traveler profile in the traveler profile database 28, personal information can be automatically retrieved from his or her traveler profile. The user of the social networking system 20 may lack a traveler profile in the traveler profile database 28. In this instance, the social network user may be prompted by the group travel management system 18 to enter personal information in order to subscribe to the application at the group travel management system 18.

In block 306, if a social network user (e.g., a friend) indicates during the session that he or she wants to join the trip of a trip owner as a trip participant, the group travel management system 18 will send a request to the reservation system 12 to create one or more offers for travel that are presented to the potential trip participant. The reservation system 12 may automatically determine travel proposals based on the itinerary for the existing reservation stored as elements in the trip owner's travel record and any constraints provided by the potential trip participant. The reservation system 12 may retrieve the travel proposals for the potential trip participant from the offers database 26.

The one or more offers determined by the reservation system 12 may attempt to replicate the details of the itinerary for the trip owner so as to provide travel proposals to the potential trip participant with identical or similar reservation details. To that end, when creating offers from the travel record for the trip owner, the reservation system 12 may attempt to replicate the elements (e.g., travel segments) of the reservation in the trip owner's travel record depending on their availability in inventory. The reservation system 12 may copy one or more bookings from the existing travel record of the trip owner to one or more offers. If an element is not available, the reservation system 12 may search for a travel product that shares a threshold level of similarity with the commensurate travel product in the itinerary of the trip owner.

The reservation system 12 may consider geographic constraints provided by the social network user seeking to join the trip as a trip participant when creating the travel proposals for the offers. In particular, the potential trip participant may want depart from a different departure location than given in the published trip of the trip owner. For example, if the potential trip participant does not reside in the same city or country as the residence of the trip owner, the group travel management system 18 may receive a departure city or a departure airport different from the reservation for the trip owner as a geographic constraint, and provide that geographic constraint to the reservation system 12 in the request. The reservation system 12 will search for travel products and create travel proposals based on the geographic constraint for presentation by the group travel management system 18 to the potential trip participant in the one or more offers.

As an example relating to flights as travel products, the reservation system 12 may attempt to create one or more offers for a trip participant that include travel on the same outbound flight segment as the outbound flight segment recorded as an element in the travel record of the trip owner. Alternatively, if the trip participant wants to depart from another location, the reservation system 12 may attempt to create travel proposals for one or more offers that include travel on a different outbound flight segment departing at a different departure time from the same airport as the outbound flight segment of the trip owner, or travel proposals for one or more offers that include travel on a different outbound flight segment departing from the same airport at a departure time closest to the departure time of the outbound flight segment of the trip owner.

An another example relating to flights as travel products, the reservation system 12 may consider date constraints provided by the social network user seeking to join the trip as a trip participant when creating the travel proposals for the offers. In particular, the potential trip participant may want depart on a different date than the departure date of the trip owner given in the published trip.

As another example for hotel as travel products, the reservation system 12 may attempt to create travel proposals for one or more offers for a trip participant that include a room booked in the same hotel as the hotel recorded as an element in the travel record of the trip owner. If the same hotel is not available over the travel dates, the system group travel management system may attempt to expand the geographic criteria by searching for alternative hotels for inclusion in the travel proposals based on proximity to the hotel in the trip record for the trip owner. For example, the group travel management system may search for alternative hotels based on proximity (e.g., the same street or city block) of the address of the alternative hotels to the address of the hotel in the travel record of the trip owner. If the search based on address proximity is successful, then the alternative hotels may be included as trip proposals constituting the one or more offers. If the search based on address proximity is not successful, the reservation system 12 further expand the search for alternative hotels to a larger geographic area in successive searches. For example, the group travel management system may search for alternative hotels within the same zip code as the hotel of the trip owner or for alternative hotels having the same city code as the hotel of the trip owner.

The travel record containing the elements of the reservation for the trip owner may include one or more non-GDS segments as extended content. The reservation system 12 may create one or more identical non-GDS segments in a travel proposal associated with an offer that match the non-GDS segments in the travel record associated with the trip owner. These non-GDS segments may be marked with a pending status in the extended content because the travel agent may need to perform additional actions to complete the booking Once the travel agent has booked the non-GDS segments in the external reservation system, the status may be converted from pending to confirmed.

In block 308, the reservation system 12 may generate a travel record for the potential trip participant in the travel record database 24. The travel record contains elements relating to the offers that are created. The travel record for the potential trip participant may be linked with the corresponding traveler profile in the traveler profile database 28. In an embodiment, the unique record locator of the travel record for the potential trip participant may be recorded as a data element in the corresponding traveler profile in the traveler profile database 28.

In block 310, the reservation system 12 may create a booking folder in the travel record database 24. The travel record for the potential trip participant containing the created offers and the travel record for the trip owner containing the pre-existing reservation may be stored as associated data elements in the common booking folder. In an embodiment, the unique record locators for the multiple travel records may be recorded as data elements in the common booking folder. The joint location in the booking folder provides a tangible link between the different social network users who belong to the travel group, including the trip owner and each trip participant.

In block 312, a notification is communicated from the reservation system 12 to the travel agency system 14. The notification makes the travel agency system 14 aware of the offers in the travel record of the potential trip participant in case the travel agent is contacted by the potential trip participant to book the trip specified in one of the offers.

In block 314, the one or offers are communicated from the reservation system 12 to the group travel management system 18, which subsequently communicates the one or more offers to the client device 16 of the potential trip participant. The one or more offers may be communicated to the traveler in an offer notice document sent to an e-mail address, in an email, in a text message, etc. The offers may include the details of the offers, including the pricing and segment information.

In block 316, the potential trip participant receiving the one or more offers at his or her client device 16 may review the one or more offers with the option of choosing one of the offers in order to join the trip owner's trip. If the potential trip participant elects to accept one of the offers, the potential trip participant is placed in contact with the travel agent. In a session established between client device 16 and the travel agency system 14, one of the offers can be verified and confirmed by the trip participant into a booking.

In block 318, the group travel management system 18 may monitor the travel records in the booking folder for consistency to ensure the integrity of the trip. The group travel management system 18 may perform the monitoring on demand when prompted, at regular intervals without prompting, or each time the itinerary of a participant in the trip evolves. Specifically, to ensure the consistency of a trip, the group travel management system 18 may perform several checks at booking folder level of the trip records in the booking folder, and decide whether to maintain the travel record of each trip participant in the same booking folder as the travel record of the trip owner.

For example, the group travel management system 18 may check the travel records in the common booking folder for the potential trip participants for canceled offers. The social network user seeking to join the trip may wish not to confirm any of the offers received in the offer notice. In this instance, the group travel management system 18 will determine the travel record of the potential trip participant will only contain cancelled offers, which means that this particular social network user is no longer participating in the trip of the trip owner, and may disassociate the travel record of this social network user from the common booking folder that contains the travel record for the trip owner and the travel records of any other trip participants.

As another example, the group travel management system 18 may check for a travel record of a trip participant who has canceled his or her trip, even if the booking was previously confirmed. Because the travel record of such a trip participant is no longer associated with the trip of the trip owner, the group travel management system 18 may disassociate the travel record of the trip participant from the common booking folder containing the travel record for the trip owner and the travel records of any other trip participants.

As another example, the group travel management system 18 may check for a modification to the itinerary of a trip participant that causes the itinerary to correspond to a different trip than the trip of the trip owner. After the booking is finalized, a trip participant may modify the itinerary contained in the travel record inside the common booking folder. For example, a travel product such as a flight or a hotel may be removed from the itinerary. To ensure that the booking folder does not contain travel records representing different trips, the group travel management system 18 executes an algorithm to check for coincidence between the travel dates and destination for the trip in the travel record of the trip participant and the dates and destination for the trip in the travel record of the trip owner. If the travel dates and destination do not match, the group travel management system 18 may disassociate the travel record for the trip participant from the common booking folder that contains the travel record for the trip owner and the travel records of any other trip participants.

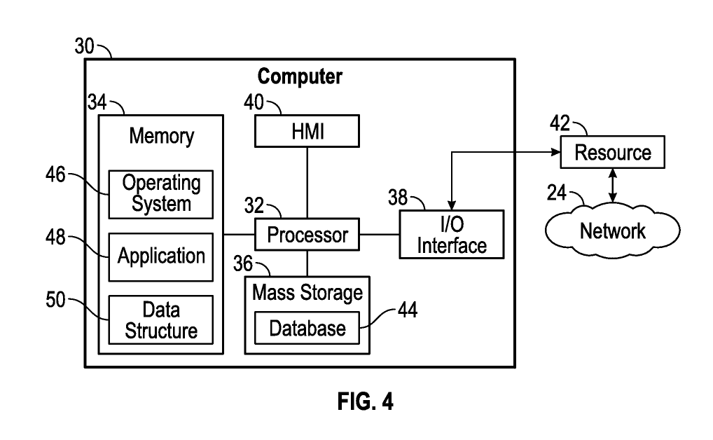

With reference to FIG. 4, the reservation system 12, travel agency system 14, client devices 16, group travel management system 18, and social networking system 20 of operating environment 10 may be implemented on one or more computer devices or servers, such as exemplary computer system 30. The computer system 30 may include a processor 32, a memory 34, a mass storage memory device 36, an input/output (I/O) interface 38, and a Human Machine Interface (HMI) 40. The computer system 30 may also be operatively coupled to one or more external resources 42 via the network 22 or I/O interface 38. External resources may include, but are not limited to, servers, databases, mass storage devices, peripheral devices, cloud-based network services, or any other suitable computer resource that may be used by the computer system 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 36 may include data storage devices such as a hard drive, optical drive, tape drive, volatile or non-volatile solid state device, or any other device capable of storing information.

The processor 32 may operate under the control of an operating system 46 that resides in memory 34. The operating system 46 may manage computer resources so that computer program code embodied as one or more computer software applications, such as an application 48 residing in memory 34, may have instructions executed by the processor 32. In an alternative embodiment, the processor 32 may execute the application 48 directly, in which case the operating system 46 may be omitted. One or more data structures 49 may also reside in memory 34, and may be used by the processor 32, operating system 46, or application 48 to store or manipulate data.

The I/O interface 38 may provide a machine interface that operatively couples the processor 32 to other devices and systems, such as the network 22 or external resource 42. The application 48 may thereby work cooperatively with the network 22 or external resource 42 by communicating via the I/O interface 38 to provide the various features, functions, applications, processes, or modules comprising embodiments of the invention. The application 48 may also have program code that is executed by one or more external resources 42, or otherwise rely on functions or signals provided by other system or network components external to the computer system 30. Indeed, given the nearly endless hardware and software configurations possible, persons having ordinary skill in the art will understand that embodiments of the invention may include applications that are located externally to the computer system 30, distributed among multiple computers or other external resources 42, or provided by computing resources (hardware and software) that are provided as a service over the network 22, such as a cloud computing service.

The HMI 40 may be operatively coupled to the processor 32 of computer system 30 in a known manner to allow a user to interact directly with the computer system 30. The HMI 40 may include video or alphanumeric displays, a touch screen, a speaker, and any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A user interface may be made available on the HMI 40 of the client device 16 by an application at the group travel management system 18, and may be used to display trips and information relating to relevant trips in a social view. The user interface may be in the form of a dashboard that aggregates the trips that the social network user has organized or cloned, and trips that the social network user has joined. From the dashboard, a particular social network user may be able to have a global view on other social network users who have joined his or her trips, and the social network user who organized each trip that was joined by the particular social network user. Records displayed on the dashboard can be active travel records or historical travel records. The itinerary content (e.g., air, hotel, leisure activity, etc.) of each travel record may be displayed on the dashboard. The dashboard may also serve as an entry point for adding and sharing new trips. The displayed list on the dashboard may be enriched with the images obtained from the profiles of the social network users.

The dashboard may be used to display a list of trips based upon a traveler profile. For each reservation, a corresponding booking folder is retrieved, which provides a list of participants and their social network identity, based on the link between bookings and the traveler profile in the traveler profile database 28. This data can be used to display a list of the social network users who have joined a trip organized by the end-user (e.g., the trip owner) and/or a list of organized trips in which the end-user participates.

A database 44 may reside on the mass storage memory device 36, and may be used to collect and organize data used by the various systems and modules described herein. The database 44 may include data and supporting data structures that store and organize the data. In particular, the database 44 may be arranged with any database organization or structure including, but not limited to, a relational database, a hierarchical database, a network database, an object-oriented database, or combinations thereof. A database management system in the form of a computer software application executing as instructions on the processor 32 may be used to access the information or data stored in records of the database 44 in response to a query, where a query may be dynamically determined and executed by the operating system 46, other applications 48, or one or more modules. Although embodiments of the invention may be described herein using relational, hierarchical, network, object-oriented, or other database terminology in specific instances, persons having ordinary skill in the art will understand that embodiments of the invention may use any suitable database management model, and are not limited to any particular type of database. In an embodiment of the invention, the database 46 may comprise the travel record database 24, the offers database 26, and/or the traveler profile database 28.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatus, or other devices to function in a particular manner, such that the instructions stored in the computer-readable medium produce an article of manufacture including instructions that implement the functions, acts, and/or operations specified in the flow-charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. For example, a social network user may receive inspiration from their friends to clone a trip. The cloned trip may be inspired by a past trip from a travel record with past or flown segments or an archived travel record that is accessible through the application at the group travel management system. The social network user may modify the dates for the itinerary of the cloned trip, which adds flexibility if the social network user wants to take the same trip with different departure and return dates. The social network user may customize the activities in the itinerary of the cloned trip by either addition or subtraction. For example, the travel record for a cultural and culinary trip being cloned may include activities at in particular museums and restaurants. However, the social network user who is cloning the trip may select culinary activities that are removed from the cloned trip, and may add activities, such as snorkeling or cinema, to the cloned trip. When creating the corresponding travel record with offers for the social network user who requests the clone, the group travel management system will not consider the created travel record as being linked with the travel record containing the trip providing inspiration for the cloned trip because it would not respect the integrity checks. Hence, the details of the cloned trip in the travel record can be shared with other social network users (e.g., friends) and become a joinable trip. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A method of forming a travel group, the method comprising:
storing, by one or more processors in a database, a first travel record containing a travel reservation for a first trip by a first social network user;
publishing the travel reservation as a trip publication on a social networking system;
receiving, at the one or more processors, an inquiry related to the trip publication via the social networking system from a client device associated with a second social network user;
in response to receiving the inquiry, generating, by the one or more processors, one or more offers for a second trip based on data in the first travel record;
storing, by the one or more processors, a second travel record containing the one or more offers in the database;
assigning, by the one or more processors, a link between the first travel record and the second travel record in a booking folder stored in the database; and
communicating the one or more offers from the one or more processors to the client device of the second social network user.

2. The method of claim 1 further comprising:
receiving an update to the first travel record at the one or more processors; and
in response to receiving the update to the first travel record, transmitting a notification to the second social network user based on the link between the first travel record and the second travel record in the booking folder.

3. The method of claim 1 further comprising:
receiving an update to the second travel record at the one or more processors; and
in response to receiving the update to the second travel record, unlinking the second travel record from the booking folder to disassociate the second travel record from the first travel record.

4. The method of claim 1 wherein publishing the travel reservation as the trip publication on the social networking system further comprises:
receiving a social network identification of the first social network user; and
retrieving the travel reservation to publish on the social networking system based on the social network identification.

5. The method of claim 1 wherein the one or more offers for the second trip are generated further based on data supplied from the client device of the second social network user with the inquiry.

6. The method of claim 5 wherein the data supplied from the client device of the second social network user with the inquiry comprises a constraint to be imposed on the one or more offers generated for the second trip.

7. The method of claim 6 wherein the first trip and the second trip share a common destination, and the constraint relates to a geographical location of a departure point for the second trip.

8. The method of claim 1 wherein the trip publication is published on the social networking system via a communication channel related to the social networking system.

9. The method of claim 1 further comprising:
communicating a notification relating to the second travel record from the one or more processors to a computer system of a travel agent.

10. A system for forming a travel group, the system comprising:
one or more processors; and
a memory coupled to the one or more processors, the memory storing data comprising a database and program code that, when executed by the one or more processors, causes the system to:
store, in the database, a first travel record containing a travel reservation for a first trip by a first social network user;
publish the travel reservation as a trip publication on a social networking system;
receive an inquiry related to the trip publication via the social networking system from a client device associated with a second social network user;
in response to receiving the inquiry, generate, one or more offers for a second trip based on data in the first travel record;
store a second travel record containing the one or more offers in the database;
assign a link between the first travel record and the second travel record in a booking folder stored in the database; and
communicate the one or more offers from the one or more processors to the client device of the second social network user.

11. The system of claim 10 wherein the program code, when executed by the one or more processors, further causes the system to:
receive an update to the first travel record; and
in response to receiving the update to the first travel record, transmit a notification to the second social network user based on the link between the first travel record and the second travel record in the booking folder.

12. The system of claim 10 wherein the program code, when executed by the one or more processors, further causes the system to:
receive an update to the second travel record; and
in response to receiving the update to the second travel record, unlink the second travel record from the booking folder to disassociate the second travel record from the first travel record.

13. The system of claim 10 wherein the program code causes the system to publish the travel reservation as the trip publication on the social networking system by:
receiving a social network identification of the first social network user; and
retrieving the travel reservation to publish on the social networking system based on the social network identification.

14. The system of claim 10 wherein the one or more offers for the second trip are generated further based on data supplied from the client device of the second social network user with the inquiry.

15. The system of claim 14 wherein the data supplied from the client device of the second social network user with the inquiry comprises a constraint to be imposed on the one or more offers generated for the second trip.

16. The system of claim 15 wherein the first trip and the second trip share a common destination, and the constraint relates to a geographical location of a departure point for the second trip.

17. The system of claim 10 wherein the trip publication is published on the social networking system via a communication channel related to the social networking system.

18. The system of claim 10 wherein the program code, when executed by the one or more processors, further causes the system to:
communicate a notification relating to the second travel record from the one or more processors to a computer system of a travel agent.

19. A computer program product for forming a travel group, the computer program product comprising:
a non-transitory computer-readable storage medium; and
program code stored on the non-transitory computer-readable storage medium that, when executed by one or more processors, causes the one or more processors to:
store, in a database, a first travel record containing a travel reservation for a first trip by a first social network user;
publish the travel reservation as a trip publication on a social networking system;
receive an inquiry related to the trip publication via the social networking system from a client device associated with a second social network user;
in response to receiving the inquiry, generate, one or more offers for a second trip based on data in the first travel record;
store a second travel record containing the one or more offers in the database;
assign a link between the first travel record and the second travel record in a booking folder stored in the database; and
communicate the one or more offers from the one or more processors to the client device of the second social network user.
